(19) United States
(12) Patent Application Publication
(10) Pub. No.: US 2022/0324035 A1
(43) Pub. Date: Oct. 13, 2022

(54) VACUUM BIT ASSEMBLY WITH REPLACEABLE DRILL BIT

(71) Applicant: MILWAUKEE ELECTRIC TOOL CORPORATION, Brookfield, WI (US)

(72) Inventors: Travis J. DuMez, Adell, WI (US); Joseph D. Greaney, Milwaukee, WI (US)

(21) Appl. No.: 17/620,964

(22) PCT Filed: Jul. 29, 2020
(86) PCT No.: PCT/US2020/043959

§ 371 Date: Dec. 20, 2021

Related U.S. Application Data
(60) Provisional application No. 62/881,534, filed on Aug. 1, 2019.

(51) Int. Cl. B23B 51/04

(52) U.S. Cl. CPC B23B 51/0473; B23B 2251/68; B25D 2217/0007

(57) ABSTRACT

A vacuum bit assembly includes an adapter having first and second ends, a central bore defined in the first end, and a locking member extending into the central bore. The vacuum bit assembly includes a drill bit having a workpiece engaging end, a connection, and a suction channel extending between the workpiece engaging and connection ends. The drill bit defines an axis of rotation that extends centrally through the drill bit between the workpiece engaging and connection ends and centrally through the adapter between the first and second ends. The drill bit includes an elongated slot adjacent the connection end. The elongated slot receives the locking member to secure the drill bit to the adapter. The vacuum bit assembly further includes a collar to selectively secure the locking member in the elongated slot. The locking member is axially movable within the elongated slot during operation of the vacuum bit assembly.

### CROSS REFERENCE TO RELATED APPLICATIONS

This application claims priority to U.S. Provisional Patent Application Ser. No. 62/881,534, filed on Aug. 1, 2019, the entire contents of which are incorporated by reference herein.

### BACKGROUND OF THE INVENTION

The present application relates to a drill bit and particularly to a vacuum bit assembly with a replaceable drill bit.

Rock drill bits are used to drill into concrete and masonry work. Typically, a lot of dust is produced as a result of the rock drill bit cutting into the workpiece. The dust is extracted through the rock drill bit by a vacuum source connected to the rock drill bit.

### SUMMARY

In one embodiment, the invention provides a vacuum bit assembly including an adapter having a first end, a second end opposite the first end, a central bore defined in the first end, and a locking member extending into the central bore. The vacuum bit assembly also includes a drill bit having a workpiece engaging end, a connection end opposite the workpiece engaging end, and a suction channel extending between the workpiece engaging and connection ends. The drill bit defines an axis of rotation that extends centrally through the drill bit between the workpiece engaging and connection ends and centrally through the adapter between the first and second ends. The drill bit includes an elongated slot adjacent the connection end. The elongated slot receives the locking member to secure the drill bit to the adapter. The vacuum bit assembly further includes a collar to selectively secure the locking member in the elongated slot. The locking member is axially movable within the elongated slot during operation of the vacuum bit assembly.

In another embodiment, the invention provides a vacuum bit assembly including an adapter having a first end, a second end opposite the first end, a central bore defined in the first end, a locking member extending into the central bore, and a pin extending into the central bore. The vacuum bit assembly also includes a drill bit having a workpiece engaging end, a connection end opposite the workpiece engaging end, and a suction channel extending between the workpiece engaging and connection ends. The drill bit defines an axis of rotation that extends centrally through the drill bit between the workpiece engaging and connection ends and centrally through the adapter between the first and second ends. The drill bit includes an aperture adjacent the connection end and a pin slot adjacent the connection end. The aperture receives the locking member to secure the drill bit to the adapter. The pin slot receives the pin to carry torque from the adapter to the drill bit. The vacuum bit assembly further includes a collar to selectively secure the locking member in the elongated slot.

In another embodiment, the invention provides a method of operating a vacuum bit. The method includes providing a vacuum bit with an adapter having a first end, a second end opposite the first end, and a locking member. The vacuum bit also includes a drill bit having a workpiece engaging end, a connection end opposite the workpiece engaging end, an elongated slot that receives the locking member, and a suction channel extending between the first and second ends. The drill bit defines an axis of rotation that extends centrally through the drill bit between the workpiece engaging and connection ends and centrally though the adapter between the first and second ends. The vacuum bit further includes a collar to selectively secure the locking member in the elongated slot. The method also includes providing a power tool operable to transfer an impact force to the vacuum bit, coupling the drill bit to the adapter, coupling the adapter to the power tool, applying an impact force from the power tool to the adapter, and transferring the impact force axially along the axis of rotation from the adapter to the drill bit while allowing the locking member to move axially within the elongated slot.

Other aspects of the invention will become apparent by consideration of the detailed description and accompanying drawings.

### BRIEF DESCRIPTION OF THE DRAWINGS

FIG. 1 is a perspective view of a vacuum bit assembly.

FIG. 2 is an exploded view of the vacuum bit assembly of FIG. 1.

FIG. 3 is a cross-sectional view of the vacuum bit assembly of FIG. 1 taken along lines 3-3.

FIG. 4 is a cross-sectional view of the vacuum bit assembly of FIG. 1 taken along lines 4-4.

FIG. 5 is a cross-sectional view of the vacuum bit assembly of FIG. 1 taken along lines 5-5.

FIG. 6 is a cross-sectional view of the vacuum bit assembly of FIG. 1 taken along lines 6-6.

FIG. 7 is perspective view of a hammer drill to be used with the vacuum bit assembly of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

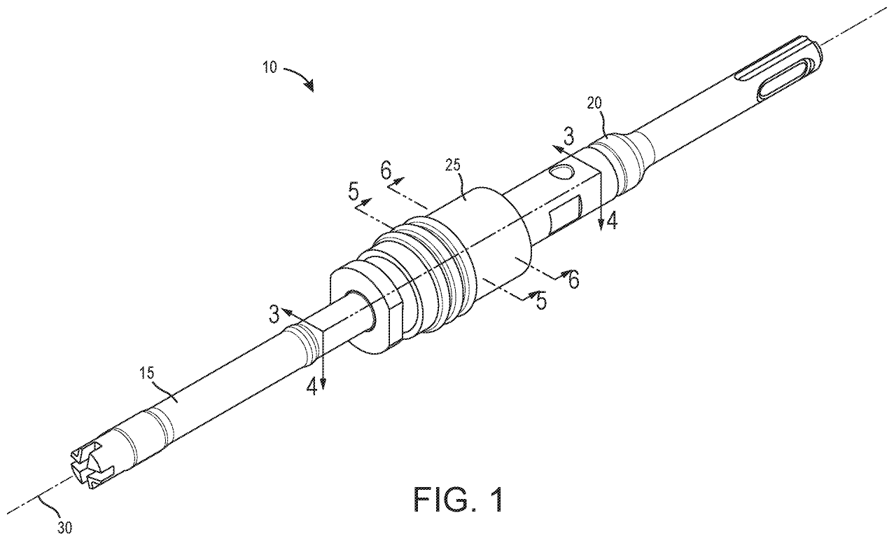

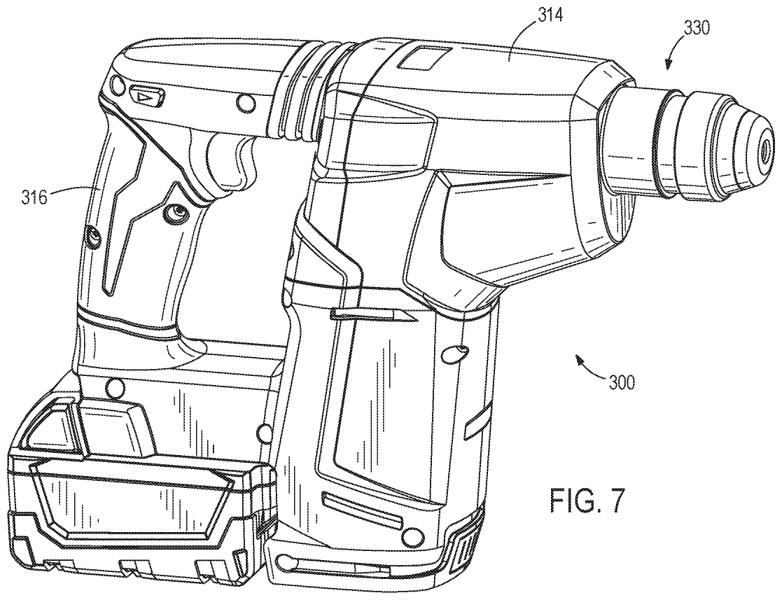

FIG. 1 illustrates a vacuum bit assembly 10 that is selectively coupled to a power tool such as a hammer drill, rotary hammer 300 (FIG. 7), or a percussion drill. The rotary hammer 300 includes a housing 314 and a handle 316 coupled to the housing 314. The rotary hammer 300 further includes a motor (not shown) disposed within the handle 314 and a rotatable spindle 330 coupled to the motor for receiving torque from the motor. The vacuum bit assembly 10 may be secured to the spindle 330 for co-rotation with the spindle 330. In addition, the rotary hammer 300 includes an impact mechanism (not shown) for delivering repeated impacts to the vacuum bit assembly 10.

In the illustrated embodiment, the connection between the vacuum bit assembly 10 and the power tool is commonly referred to as a Special Direct System (SDS) plus connection. In other embodiments, the connection between the vacuum bit assembly 10 and the power tool can be a different type of SDS connection (e.g., SDS top connection, SDS max connection, etc.). The vacuum bit assembly 10 includes a replaceable drill bit 15, an adapter 20, and a collar 25. The power tool is operable to rotate the adapter 20 and the drill bit 15 about an axis of rotation 30. In addition, the power tool may be operable to transfer an impact force (e.g., a percussion force) axially along the axis of rotation 30 from the adapter 20 to the drill bit 15. Although not shown, the vacuum bit assembly 10 may further include a suction adapter. The suction adapter includes an attachment that may be connected to a vacuum source to facilitate removal of dust and debris produced during a drilling operation.

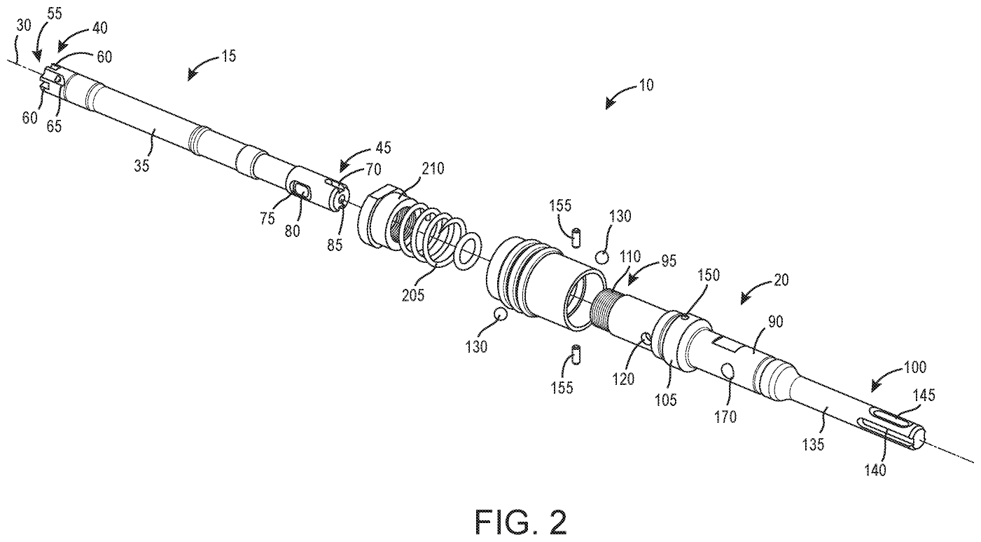

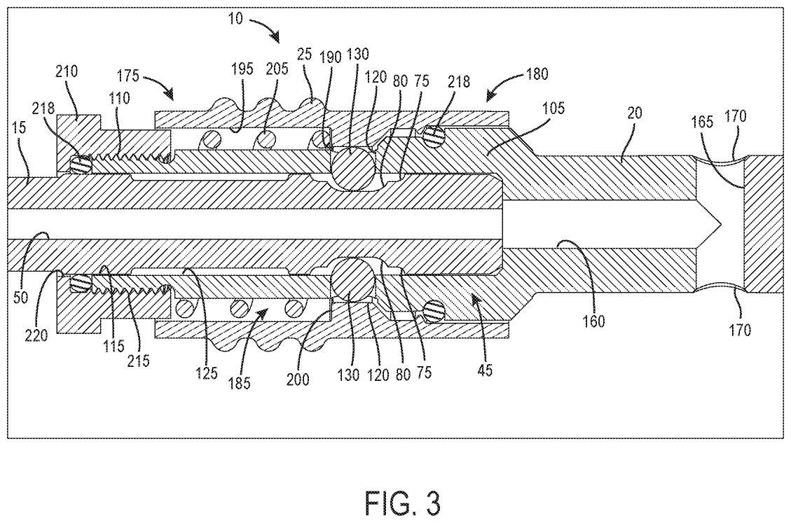

With reference to FIG. 2, the drill bit 15 includes a drill bit body 35 having a first end 40 (e.g., a workpiece engaging end), a second end 45 (e.g., connection end) opposite the first end 40, and a suction channel 50 (FIG. 3) extending between the first and second ends 40, 45. In the illustrated embodiment, the first end 40 includes a carbide cutting element 55. The carbide cutting element 55 is a four-cutter including four separate cutting lips 60. Two cutting lips 60 on diametrically opposite sides of the axis of rotation 30 from each other include an aperture 65 (although only one aperture 65 is shown in FIG. 2) that extends into the suction channel 50 to further assist in dust and debris removal. In other embodiments, the first end 40 of the drill bit 15 may have other types of cutting elements or configurations.

The second end 45 of the drill bit 15 includes a pair of pin slots 70 and a pair of elongated slots 75 (although only one pin slot 70 and one elongated slot 75 is shown in FIG. 2). The pin slots 70 are on diametrically opposite sides of the axis of rotation 30 from one another. Similarly, the elongated slots 75 are on diametrically opposite sides of the axis of rotation 30 from one another other. In some embodiments, the drill bit 15 may only include a single pin slot 70 and/or a single elongated slot 75, or the drill bit 15 may include more than two pin slots 70 and/or elongated slots 75. Each illustrated pin slot 70 is positioned 90 degrees from an adjacent elongated slot 75 and vice versa. The elongated slots 75 further include an indent 80 that is further recessed into the drill bit body 35 in a direction radially toward the axis of rotation 30 than the elongated slot 75.

The suction channel 50 includes an opening (not shown) adjacent the carbide cutting element 55 to facilitate dust and debris removal from a workpiece. The suction channel 50 also includes an opening 85 adjacent the second end 45 to transfer the dust and debris to the adapter 20.

With continued reference to FIG. 2, the adapter 20 includes a body 90 having a first end 95, a second end 100 opposite the first end 95, and a flange 105 that separates the first end 95 from the second end 100. The first end 95 includes threads 110 and defines an opening 115 (FIG. 3) that receives the second end 45 of the drill bit 15. The first end 95 also includes two opposing cylindrical apertures 120 (only one cylindrical aperture is illustrated in FIG. 2). The cylindrical apertures 120 are spaced 180 degrees from each other and are in communication with a central bore 125 (FIG. 3) that the opening 115 extends into. In some embodiments, the adapter 20 may only include a single cylindrical aperture 120 or may include more than two cylindrical apertures 120. Each cylindrical aperture 120 is sized to receive a locking member (e.g., a ball bearing or a locking sphere 130) so that a portion of each locking sphere 130 extends into the central bore 125. In other embodiments, a plug or protrusion can be received though each cylindrical aperture 120 into the central bore 125 and fixed relative to the body 90. As best seen in FIGS. 3 and 6, each locking sphere 130 is received in one of the elongated slots 75, or apertures, of the second end 45 of the drill bit 15 when the drill bit 15 is coupled to the adapter 20. More specifically, each locking sphere 130 is received in the indent 80 of one of the elongated slots 75. In the illustrated embodiment, the indent 80 is sized to allow the portion of the locking sphere 130 that extends into the elongated slot 75 to move within the elongated slot. In addition, a length of the elongated slot 75 is larger than a diameter of the locking sphere 130. In some embodiments, the length of the elongated slot 75 is at least fifty percent bigger than the diameter of the locking sphere 130. In other embodiments, the length of the elongated slot 75 may be two or three times the diameter of the locking sphere 130. As such, movement between the adapter 20 and the drill bit 15 is allowed during a hammering operation.

With reference back to FIG. 2, the second end 100 of the body 90 of the adapter 20 defines a shank 135 that is configured to couple the vacuum bit assembly 10 to a power tool. The shank 135 includes two opposing channels 140 and two opposing grooves 145, which collectively define a SDS plus interface. In other embodiments, the shank 135 may have other suitable configurations for connection to a desired power tool.

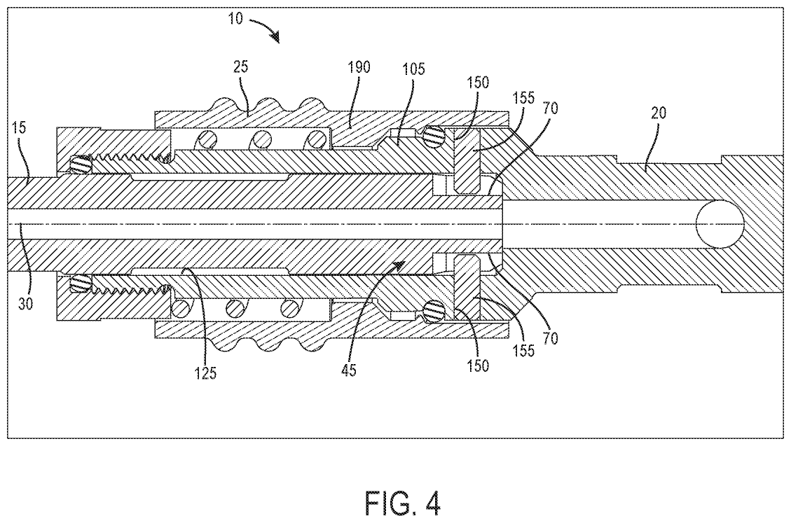

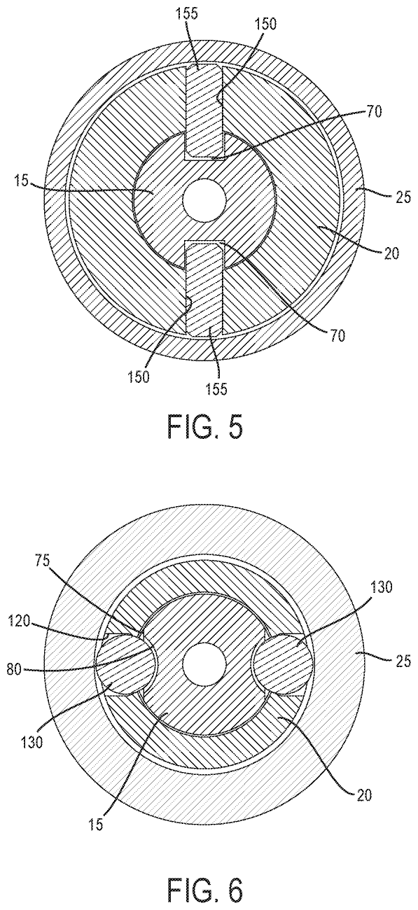

The flange 105 extends circumferentially about the body 90 and extends radially further outwards from the axis of rotation 30 than the rest of the body 90. The flange 105 includes two opposing pin apertures 150 (although only one pin aperture 150 is shown in FIG. 2) that are spaced 180 degrees from each other. In other embodiments, the flange 105 may only include a single pin aperture 150 or may include more than two pin apertures 150. The pin apertures 150 each receive a pin 155 that extends into the central bore 125 radially toward the axis of rotation 30. In the illustrated embodiment, the pins 155 are inserts that are coupled to the body 90 (e.g., by a press fit engagement, by a brazing process or the like). In other embodiments, the pins 155 may be integrally formed with the body 90. As best seen in FIGS. 4 and 5, the pins 155 engage the pin slots 70 on the second end 45 of the drill bit 15 to fix rotation of the drill bit 15 relative to the adapter 20. Additionally, the pins 155 are movable axially in a direction parallel to the axis of rotation 30 relative to the pin slots 70 during a hammering operation. The pins 155, thereby, carry torque from the adapter 20 to the drill bit 15.

As seen in FIG. 3, the adapter 20 further includes a suction channel 160 that, when the adapter 20 is coupled to the drill bit 15, is in communication with the suction channel 50 of the drill bit 15. The suction channel 160 extends from the central bore 125 to an exhaust passage 165 that extends in a direction perpendicular to the axis of rotation 30. The exhaust passage 165 includes two exhaust openings 170 on opposing sides of the body 90 of the adapter 20. The exhaust openings 170 open into a suction adapter (when one is attached) to facilitate removal of dust and debris.

Referring to FIG. 3, the collar 25 includes a first end 175, a second end 180 opposite the first end 175, and a central channel 185 extending from the first end 175 to the second end 180. A rib 190 extends radially from an inside surface 195 of the central channel 185 to separate the first end 175 from the second end 180. The rib 190 defines a spring seat 200 on a side of the rib 190 facing the first end 175 of the collar 25. A resilient member (e.g., a spring 205) positioned between the collar 25 and the adapter 20 engages the spring seat 200. The spring 205 biases the collar 25 toward the shank 135 of the adapter 20. The rib 190 is positioned adjacent the cylindrical apertures 120 when the vacuum bit assembly 10 is assembled to secure the locking spheres 130 within the cylindrical apertures 120 and within the elongated slot 75.

When the vacuum bit assembly 10 is assembled, the first end 95 of the adapter 20 is positioned within the central channel 185 of the collar 25. A nose 210 with internal threads 215 is coupled to the threads 110 on the first end 95 of the adapter 20 to secure the adapter 20 to the collar 25. The spring 205 is positioned in the spring seat 200 between the nose 210 and the rib 190 of the collar 25. The spring 205 biases the collar 25 away from the nose 210 so that the rib 190 of the collar 25 contacts the flange 105 of the adapter 20. In the illustrated embodiment, a seal 218 may be positioned between the nose 210 and the first end 95 of the adapter 20 to inhibit dust and debris from entering the central bore 125 of the adapter 20 or the central channel 185 of the collar 25. In addition, the seal 218 may assist in absorbing impacts between the collar 25 and the adapter 20 during a hammering operation. In some embodiments, the seal 218 may be an O-ring. In other embodiments, the seal 218 may have other suitable configurations.

As mentioned above, the drill bit 15 is replaceable. For example, if the carbide cutting element 55 is damaged during a drilling operation, the drill bit 15 may be selectively removed from the vacuum bit assembly 10 and replaced with a new drill bit 15. Alternatively, a drill bit of a different size may be coupled to the vacuum bit assembly 10. To connect the drill bit 15 to the adapter 20, and thus the vacuum bit assembly 10, a user may press the collar 25 against the bias of the spring 205 towards the nose 210, moving the position of the rib 190 relative to the adapter 20. As the collar 25 moves towards the nose 210, the rib 190 is displaced relative to the cylindrical apertures 120, allowing the locking spheres 130 to move within the cylindrical apertures 120. A user may then insert the second end 45 of the drill bit 15 into an opening 220 of the nose 210 and into the central bore 125 of the adapter 20. As a user slides the drill bit 15 into the central bore 125, the second end 45 of the drill bit 15 moves the locking spheres 130 out of the cylindrical apertures 120 allowing the drill bit 15 to pass. Simultaneously, a user may twist the drill bit about the axis of rotation 30 until the pins 155 of the adapter 20 align with the pin slots 70 of the drill bit 15, allowing the drill bit 15 to further slide into the central bore 125. Once the second end 45 of the drill bit 15 is fully within the central bore 125, the user may release the collar 25, allowing the spring 205 to bias the collar 25 away from the nose 210. As the collar 25 moves away from the nose 210, the rib 190 forces the locking spheres 130 into the indents 80 of the elongated slots 75.

With the drill bit 15 secured to the adapter 20, the adapter 20 may be coupled to a power tool to rotate the drill bit 15 and the adapter 20 about the axis of rotation 30 together. Additionally, the power tool may provide an impact force to the adapter 20. The adapter 20 transfers the impact force axially along the axis of rotation 30 to the drill bit 15 to assist in removing rock and other materials from a workpiece.

To remove the drill bit 15 from the adapter 20, and thus the vacuum bit assembly 10, a user may again move the collar 25 against the bias of the spring 205 towards the nose 210, allowing the locking spheres 130 to move within the cylindrical apertures 120. With the locking spheres 130 capable of moving within the cylindrical apertures 120, the drill bit 15 may be pulled axially along the axis of rotation 30 out of the central bore 125 of the adapter 20. A new drill bit 15 may then be attached to the adapter 20 in the same way discussed above.

During operation, the second end 100 of the adapter 20 of the vacuum bit assembly 10 may be coupled to a power tool (e.g., hammer drill, rotary hammer 300, or percussion drill). The power tool provides an impact force to the vacuum bit assembly 10 to cause the first end 40 of the drill bit 15 to strike a workpiece. The impact force is transferred axially along the axis of rotation 30 from the power tool to the adapter 20 and from the adapter 20 to the drill bit 15. Meanwhile, as the adapter 20 is transferring the impact force to the drill bit 15, the locking spheres 130 move axially within the elongated slot 75 and the pins 155 move axially within the pin slots 70 to reduce fatigue on the vacuum bit assembly 10.

Providing a vacuum bit assembly 10 including an adapter 20 and a drill bit 15 selectively attached to the adapter 20 allows for the easy and simple replacement of a damaged drill bit 15. In addition, providing an engagement between the adapter 20 and the drill bit 15 that includes an elongated slot 75 with an indent 80 to allow a locking member 130 to move within the elongated slot 75 during a hammering operation reduces the fatigue on the vacuum bit assembly 10. Further, providing pin slots 70 on a drill bit 15 that allows pins 155 on an adapter 20 to move axially within the pin slots 70 while fixing rotation assists in carrying the torque from the adapter 20 to the drill bit 15 while minimizing the effect of any axial impact force transferred between the adapter 20 and the drill bit 15.

Although the invention is described with reference to discrete embodiments of a vacuum bit assembly, variations of the vacuum bit assembly exist within the spirit and scope of the invention.

Various features and advantages of the invention are set forth in the following claims.

What is claimed is:

1. A vacuum bit assembly comprising:
an adapter having a first end, a second end opposite the first end, a central bore defined in the first end, and a locking member extending into the central bore;
a drill bit having a workpiece engaging end, a connection end opposite the workpiece engaging end, and a suction channel extending between the workpiece engaging and connection ends, the drill bit defining an axis of rotation that extends centrally through the drill bit between the workpiece engaging and connection ends and centrally through the adapter between the first and second ends, the drill bit including an elongated slot adjacent the connection end, the elongated slot receiving the locking member to secure the drill bit to the adapter; and
a collar to selectively secure the locking member in the elongated slot,
wherein the locking member is axially movable within the elongated slot during operation of the vacuum bit assembly.

2. The vacuum bit of claim 1, wherein the elongated slot has an indent that is further recessed in a direction extending radially toward the axis of rotation.

3. The vacuum bit of claim 1, wherein the locking member is a locking sphere.

4. The vacuum bit of claim 1, wherein the elongated slot is a first elongated slot, and wherein the drill bit includes a second elongated slot adjacent the connection end on a diametrically opposite side of the axis of rotation from the first elongated slot.

5. The vacuum bit of claim 4, wherein the locking member is a first locking member, wherein the adapter includes a second locking member received in the second elongated slot, and wherein the second locking member is axially movable within the second elongated slot during operation of the vacuum bit assembly.

6. The vacuum bit of claim 1, wherein the drill bit includes a pin slot adjacent the connection end, wherein the adapter includes a pin received in the pin slot, and wherein the pin is axially movable within the pin slot.

7. The vacuum bit of claim 6, wherein the elongated slot is positioned 90 degrees about the axis of rotation from the second slot.

8. The vacuum bit of claim 1, wherein a length of the elongated slot is at least fifty percent greater than a diameter of the locking member.

9. The vacuum bit of claim 1, wherein the collar is biased by a resilient member to secure the locking member within the slot.

10. The vacuum bit of claim 9, wherein the resilient member biases the collar in a direction away from the workpiece engaging end of the drill bit.

11. The vacuum bit of claim 1, wherein the collar defines a rib that extends radially from an inside surface of the collar towards the adapter, and wherein the rib is positioned adjacent the locking member to secure the locking member within the elongated slot.

12. The vacuum bit of claim 1, wherein the drill bit is selectively removable from the adapter.

13. A vacuum bit assembly comprising:
an adapter having a first end, a second end opposite the first end, a central bore defined in the first end, a locking member extending into the central bore, and a pin extending into the central bore;
a drill bit having a workpiece engaging end, a connection end opposite the workpiece engaging end, and a suction channel extending between the workpiece engaging and connection ends, the drill bit defining an axis of rotation that extends centrally through the drill bit between the workpiece engaging and connection ends and centrally through the adapter between the first and second ends, the drill bit including an aperture adjacent the connection end and a pin slot adjacent the connection end, the aperture receiving the locking member to secure the drill bit to the adapter, the pin slot receiving the pin to carry torque from the adapter to the drill bit; and
a collar to selectively secure the locking member in the elongated slot.

14. The vacuum bit of claim 13, wherein the aperture is positioned 90 degrees about the axis of rotation from the pin slot.

15. The vacuum bit of claim 13, wherein the aperture is a first aperture and the pin slot is a first pin slot, wherein the drill bit further includes a second aperture adjacent the connection end on a diametrically opposite side of the axis of rotation from the first aperture, and a second pin slot adjacent the connection end on a diametrically opposite side of the axis of rotation from the first pin slot.

16. The vacuum bit of claim 15, wherein the locking member is a first locking member and the pin is a first pin, and wherein the adapter further includes a second locking member received in the second aperture and a second pin received in the second pin slot.

17. The vacuum bit of claim 16, wherein the first aperture, the second aperture, the first pin slot, and the second pin slot are positioned 90 degrees from each other.

18. The vacuum bit of claim 13, wherein the locking member and the pin are axially movable within the aperture and the pin slot, respectively.

19. A method of operating a vacuum bit, the method comprising:
providing a vacuum bit including
an adapter having a first end, a second end opposite the first end, and a locking member,
a drill bit including a workpiece engaging end, a connection end opposite the workpiece engaging end, an elongated slot that receives the locking member, and a suction channel extending between the first and second ends, the drill bit defining an axis of rotation that extends centrally through the drill bit between the workpiece engaging and connection ends and centrally though the adapter between the first and second ends, and
a collar to selectively secure the locking member in the elongated slot;
providing a power tool operable to transfer an impact force to the vacuum bit;
coupling the drill bit to the adapter;
coupling the adapter to the power tool;
applying an impact force from the power tool to the adapter; and
transferring the impact force axially along the axis of rotation from the adapter to the drill bit while allowing the locking member to move axially within the elongated slot.

20. The method of claim 20, wherein the adapter further includes a pin and the drill bit further includes a pin slot adjacent the connection end, and wherein transferring the impact force further includes allowing the pin to move axially within the pin slot.
